(19) United States
(12) Patent Application Publication
(10) Pub. No.: US 2023/0010588 A1
(43) Pub. Date: Jan. 12, 2023

(54) COORDINATED TUNE AWAY FOR MULTI-SIM DEVICES

(71) Applicant: QUALCOMM Incorporated, San Diego, CA (US)

(72) Inventors: Syam Pavan VADAPALLI, Visakhapatnam (IN); Roop Sagar INAKOLLU, Nellore (IN); AnkammaRao RAVUVARI, Hyderabad (IN)

(21) Appl. No.: 17/369,340

(22) Filed: Jul. 7, 2021

(51) Int. Cl. H04W 72/12; H04W 72/14

(52) U.S. Cl. CPC H04W 72/1284; H04W 72/14

(57) ABSTRACT

Aspects of the present disclosure provide techniques for coordinated tune away for multiple subscriber identity module (SIM) devices. A method by a user equipment includes communicating with a first base station (BS) of a first radio access network (RAN) in a connected mode using a first subscription associated with a first SIM of the UE, wherein the UE: includes a second subscription associated with a second SIM for communicating with a second BS of a second RAN, and operates in an idle mode associated with the second subscription while communicating using the first subscription; determining a tune away associated with the first RAN will occur to allow the UE to perform one or more first actions associated with the second subscription; and transmitting information to the first BS indicating the tune away and a request to suspend one or more second actions associated with the first subscription.

### INTRODUCTION

Aspects of the present disclosure relate to wireless communications, and more particularly, to techniques for coordinated tune away for multiple subscriber identity module (multi-SIM) devices.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

Certain aspects can be implemented in a method for wireless communication performed by a base station (BS) of a first radio access network (RAN). The method generally includes communicating with a user equipment (UE) in a connected mode using a first subscription associated with a first subscriber identity module (SIM) of the UE, receiving information from the UE indicating that a tune away associated with the first RAN will occur to allow the UE to perform one or more first actions associated with a second subscription of the UE associated with a second SIM, wherein: the information includes at least one request to suspend one or more second actions associated with the first subscription, and receiving the information indicating that the tune away associated with the first RAN will occur comprises receiving the information prior to the tune away. The method may also include suspending the one or more second actions associated with the first subscription during the tune away.

Certain aspects can be implemented in a base station (BS) of a first radio access network (RAN) for wireless communication. The BS generally includes a memory comprising computer-executable instructions and one or more processors configured to execute the computer-executable instructions and cause the BS to: communicate with a user equipment (UE) in a connected mode using a first subscription associated with a first subscriber identity module (SIM) of the UE, receive information from the UE indicating that a tune away associated with the first RAN will occur to allow the UE to perform one or more first actions associated with a second subscription of the UE associated with a second SIM, wherein: the information includes at least one request to suspend one or more second actions associated with the first subscription, and the one or more processors are configured to receive the information prior to the tune away. The one or more processors may also be configured to cause the BS to suspend the one or more second actions associated with the first subscription during the tune away.

Certain aspects can be implemented in a base station (BS) of a first radio access network (RAN) for wireless communication. The BS may include means for communicating with a user equipment (UE) in a connected mode using a first subscription associated with a first subscriber identity module (SIM) of the UE, means for receiving information from the UE indicating that a tune away associated with the first RAN will occur to allow the UE to perform one or more first actions associated with a second subscription of the UE associated with a second SIM, wherein: the information includes at least one request to suspend one or more second actions associated with the first subscription, and the means for receiving the information indicating that a tune away associated with the first RAN will occur include means for receiving the information prior to the tune away. The BS may also include means for suspending the one or more second actions associated with the first subscription during the tune away.

Certain aspects can be implemented in a non-transitory computer-readable medium. The non-transitory computer-readable medium may comprise computer-executable instructions that, when executed by one or more processors of a base station (BS) of a first radio access network (RAN), cause the base station (BS) to: communicate with a user equipment (UE) in a connected mode using a first subscription associated with a first subscriber identity module (SIM) of the UE, receive information from the UE indicating that a tune away associated with the first RAN will occur to allow the UE to perform one or more first actions associated with a second subscription of the UE associated with a second SIM, wherein: the information includes at least one request to suspend one or more second actions associated with the first subscription, and the computer-executable instructions that cause the BS to receive the information indicating that a tune away associated with the first RAN will occur include computer-executable instructions that cause the BS to receive the information prior to the tune away. The non-transitory computer-readable medium may also include computer-executable instructions that cause the BS to suspend the one or more second actions associated with the first subscription during the tune away.

Certain aspects can be implemented in a computer program product embodied on a computer-readable storage medium. The computer-readable storage medium may comprise code for performing wireless communication by a base station (BS) of a first radio access network (RAN) including code for: communicating with a user equipment (UE) in a connected mode using a first subscription associated with a first subscriber identity module (SIM) of the UE, receiving information from the UE indicating that a tune away associated with the first RAN will occur to allow the UE to perform one or more first actions associated with a second subscription of the UE associated with a second SIM, wherein: the information includes at least one request to suspend one or more second actions associated with the first subscription, and the code for receiving the information indicating that a tune away associated with the first RAN will occur includes code for receiving the information prior to the tune away. Additionally, the computer program product may include code for suspending the one or more second actions associated with the first subscription during the tune away.

Certain aspects can be implemented in a method for wireless communication performed by a user equipment (UE). The method generally includes communicating with a first base station (BS) of a first radio access network (RAN) in a connected mode using a first subscription associated with a first subscriber identity module (SIM) of the UE, wherein: the UE includes a second subscription associated with a second SIM for communicating with a second BS of a second RAN, and the UE operates in an idle mode associated with the second subscription while communicating with the BS using the first subscription in the connected mode. The method also includes determining a tune away associated with the first RAN will occur to allow the UE to perform one or more first actions associated with the second subscription and transmitting, prior to the tune away, information to the first BS of the first RAN indicating the tune away and at least one request to suspend one or more second actions associated with the first subscription.

Certain aspects can be implemented in a user equipment (UE) for wireless communication. The UE generally includes a memory comprising computer-executable instructions and one or more processors configured to execute the computer-executable instructions and cause the UE to: communicate with a first base station (BS) of a first radio access network (RAN) in a connected mode using a first subscription associated with a first subscriber identity module (SIM) of the UE, wherein: the UE includes a second subscription associated with a second SIM for communicating with a second BS of a second RAN, and the UE operates in an idle mode associated with the second subscription while communicating with the BS using the first subscription in the connected mode. The one or more processors may be further configured to cause the UE to determine a tune away associated with the first RAN will occur to allow the UE to perform one or more first actions associated with the second subscription and to transmit, prior to the tune away, information to the first BS of the first RAN indicating the tune away and at least one request to suspend one or more second actions associated with the first subscription.

Certain aspects can be implemented in a user equipment (UE) for wireless communication. The UE may include means for communicating with a first base station (BS) of a first radio access network (RAN) in a connected mode using a first subscription associated with a first subscriber identity module (SIM) of the UE, wherein: the UE includes a second subscription associated with a second SIM for communicating with a second BS of a second RAN, and the UE operates in an idle mode associated with the second subscription while communicating with the BS using the first subscription in the connected mode. The UE also includes means for determining a tune away associated with the first RAN will occur to allow the UE to perform one or more first actions associated with the second subscription and means for transmitting, prior to the tune away, information to the first BS of the first RAN indicating the tune away and at least one request to suspend one or more second actions associated with the first subscription.

Certain aspects can be implemented in a non-transitory computer-readable medium. The non-transitory computer-readable medium may comprise computer-executable instructions that, when executed by one or more processors of a user equipment (UE), cause the UE to: communicate with a first base station (BS) of a first radio access network (RAN) in a connected mode using a first subscription associated with a first subscriber identity module (SIM) of the UE, wherein: the UE includes a second subscription associated with a second SIM for communicating with a second BS of a second RAN, and the UE operates in an idle mode associated with the second subscription while communicating with the BS using the first subscription in the connected mode. In some cases, the non-transitory computer-readable medium further includes computer-executable instructions that cause the one or more processors of the UE to determine a tune away associated with the first RAN will occur to allow the UE to perform one or more first actions associated with the second subscription and to transmit, prior to the tune away, information to the first BS of the first RAN indicating the tune away and at least one request to suspend one or more second actions associated with the first subscription.

Certain aspects can be implemented in a computer program product embodied on a computer-readable storage medium. The computer-readable storage medium may comprise code for communicating with a first base station (BS) of a first radio access network (RAN) in a connected mode using a first subscription associated with a first subscriber identity module (SIM) of the UE, wherein: the UE includes a second subscription associated with a second SIM for communicating with a second BS of a second RAN, and the UE operates in an idle mode associated with the second subscription while communicating with the BS using the first subscription in the connected mode. In some cases, the computer-readable storage medium may further include code for determining a tune away associated with the first RAN will occur to allow the UE to perform one or more first actions associated with the second subscription and code for transmitting, prior to the tune away, information to the first BS of the first RAN indicating the tune away and at least one request to suspend one or more second actions associated with the first subscription.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example a base station and user equipment.

FIGS. 3A-3D depict various example aspects of data structures for a wireless communication network.

FIG. 4 is a call flow diagram illustrating example operations for wireless communication between a first base station, a user equipment, and a second base station based on a coordinated tune away.

FIG. 5 is a flow diagram illustrating example operations for wireless communication by a user equipment.

FIG. 6 is a flow diagram illustrating example operations for wireless communication by a base station.

FIG. 7 depicts aspects of an example communications device.

FIG. 8 depicts aspects of an example communications device.

### DETAILED DESCRIPTION

Aspects of the present disclosure provide apparatuses, methods, processing systems, and computer-readable mediums for coordinated tune away for multiple subscriber identity module (multi-SIM) devices.

For example, in some cases, a user equipment (UE) may support communication using two different subscriptions, such as a first subscription and a second subscription. For example, in some cases, the UE may communicate with a first BS of a first radio access network (RAN) using the first subscription and may communicate with a second BS of a second RAN using the second RAN. In some cases, however, the UE may only include a single transceiver and, thus, must share one or more radio frequency (RF) chains between the two subscriptions for transmitting and receiving signals from the first BS and the second BS.

In some cases, the UE, by default, may tune the one or more RF chains to the first BS of the first RAN associated with the first subscription. However, there may be cases where the UE is required to perform one or more first actions associated with the second subscription. In such cases, the UE may retune the one or more RF chains from the first BS of the first RAN to the second BS of the second RAN, known as a tune away, to perform the one or more first actions associated with the second subscription. During the tune away, the UE may not be able to receive signals from the first BS of the first RAN. Additionally, the first BS of the first RAN may not know of the tune away and the UE's absence in the first RAN. As a consequence, the first BS may continue to try to transmit signaling to the UE during the tune away, which, ultimately, may not be received by the UE, resulting in wasted time and frequency resources in the first RAN as well as wasted processing and power resources at the first BS.

Thus, aspects of the present disclosure provide techniques for a coordinated tune away that includes informing the first BS of the first RAN about an upcoming tune away gap and requesting the first BS to suspend one or more second actions associated with the first subscription, such as suspending transmitting signalling to the UE during the tune away. By suspending the one or more second actions during the tune away, the UE is free to tune to the second BS of the second RAN to perform the one or more first actions associated with the second subscription without missing signalling from the first BS of the first RAN, thereby reducing the wasted time and frequency resources in the first RAN as well as the wasted processing and power resources at the first BS.

### Introduction to Wireless Communication Networks

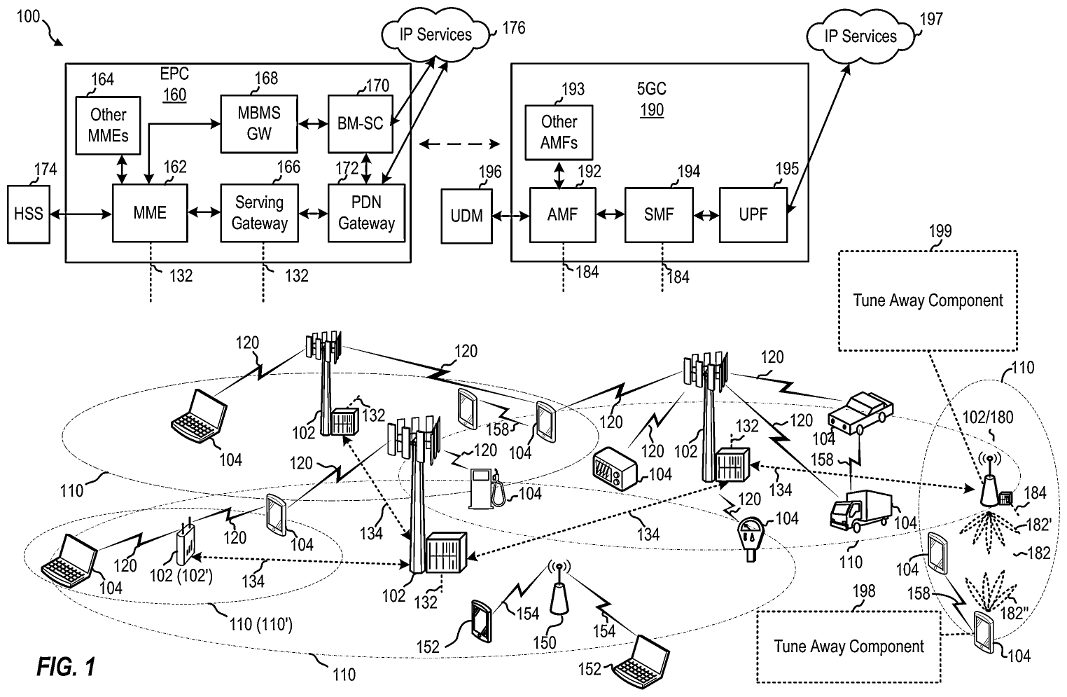

FIG. 1 depicts an example of a wireless communication network 100, in which aspects described herein may be implemented.

Generally, wireless communication network 100 includes base stations (BSs) 102, user equipments (UEs) 104, one or more core networks, such as an Evolved Packet Core (EPC) 160 and 5G Core (5GC) network 190, which interoperate to provide wireless communications services.

Base stations 102 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

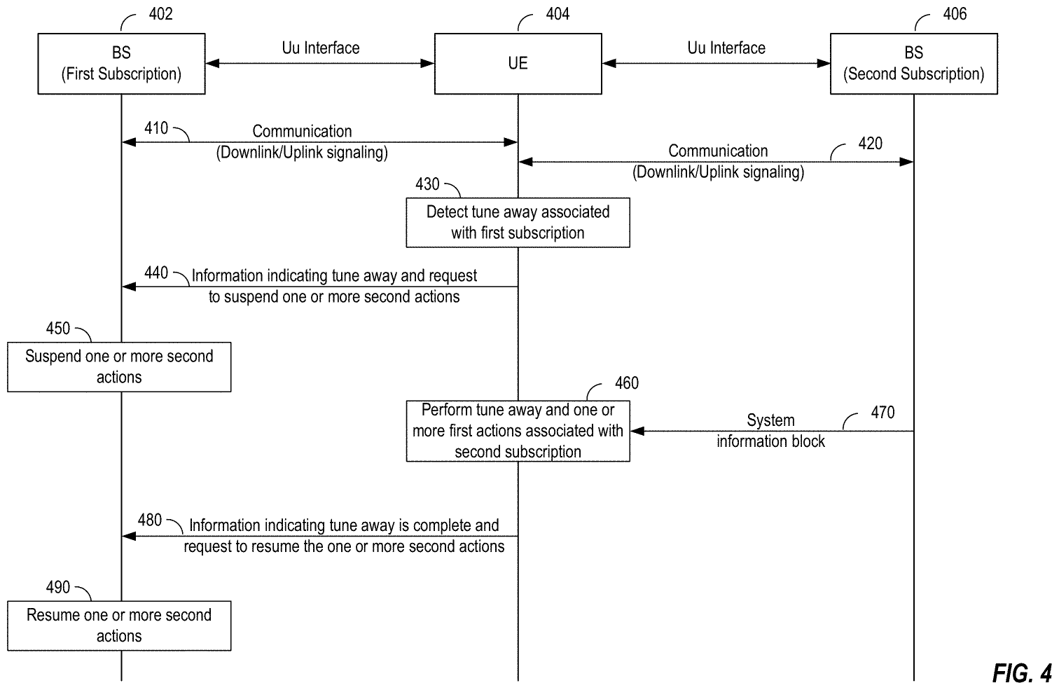

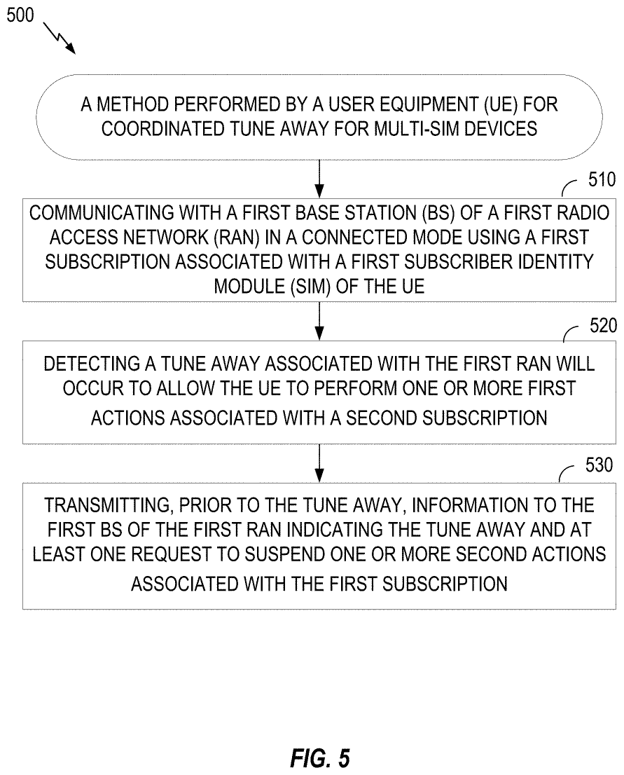

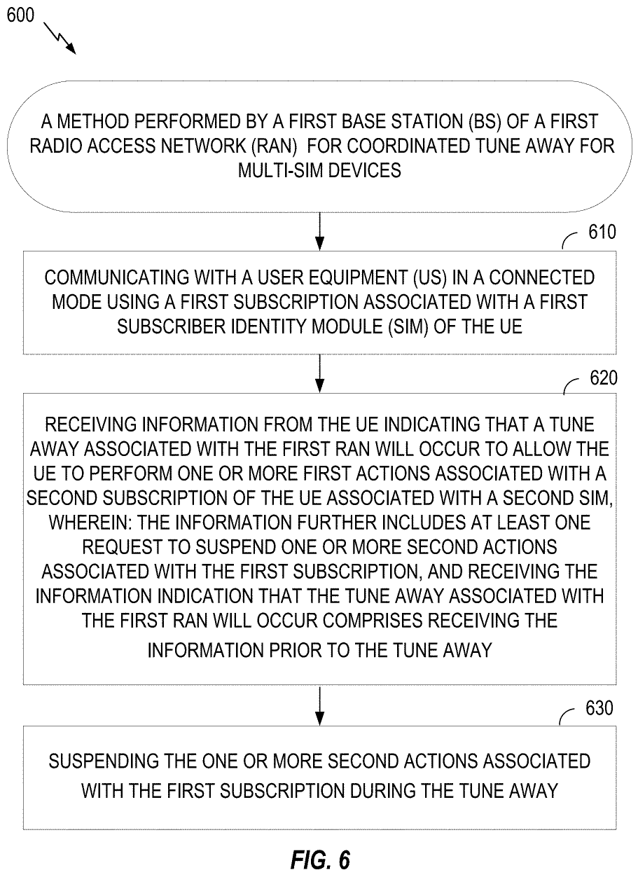

Wireless communication network 100 includes a tune away component 199, which may be configured to perform the operations in FIGS. 4 and 6, as well as other operations described herein for coordinated tune away for multi-SIM devices. Wireless communication network 100 further includes a tune away 198, which may be used configured to perform the operations in FIGS. 4 and 5, as well as other operations described herein for coordinated tune away for multi-SIM devices.

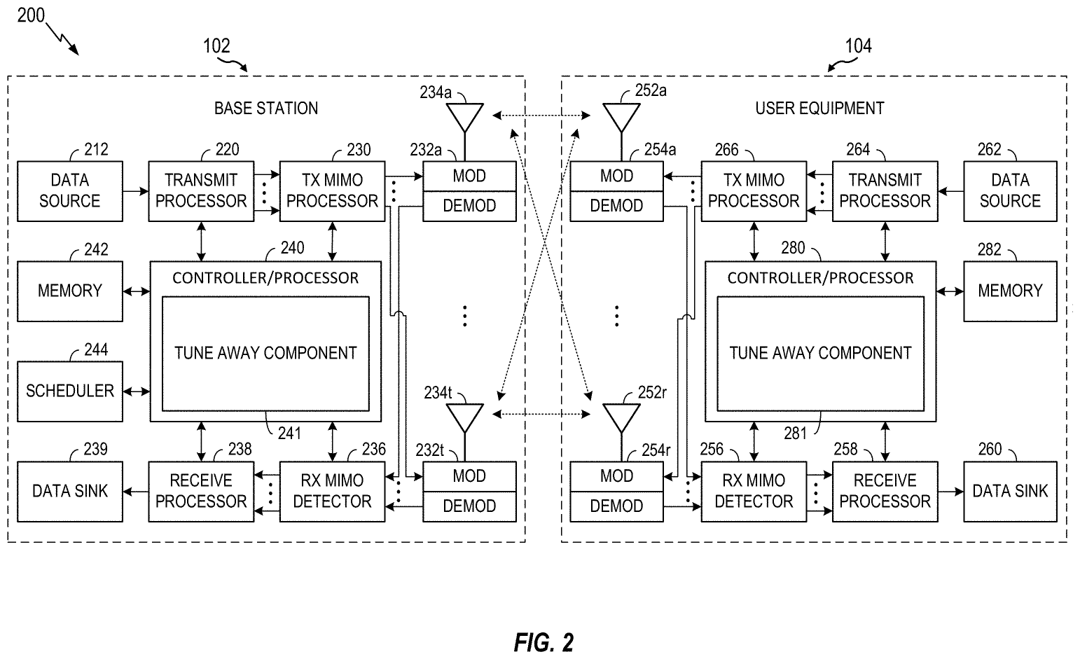

FIG. 2 depicts aspects of an example base station (BS) 102 and a user equipment (UE) 104.

Generally, base station 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, base station 102 may send and receive data between itself and user equipment 104.

Base station 102 includes controller/processor 240, which may be configured to implement various functions related to wireless communications. In the depicted example, controller/processor 240 includes tune away component 241, which may be representative of tune away component 199 of FIG. 1. Notably, while depicted as an aspect of controller/processor 240, tune away component 241 may be implemented additionally or alternatively in various other aspects of base station 102 in other implementations.

Generally, user equipment 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

User equipment 104 includes controller/processor 280, which may be configured to implement various functions related to wireless communications. In the depicted example, controller/processor 280 includes a tune away component 281, which may be representative of tune away component 198 of FIG. 1. Notably, while depicted as an aspect of controller/processor 280, tune away component 281 may be implemented additionally or alternatively in various other aspects of user equipment 104 in other implementations.

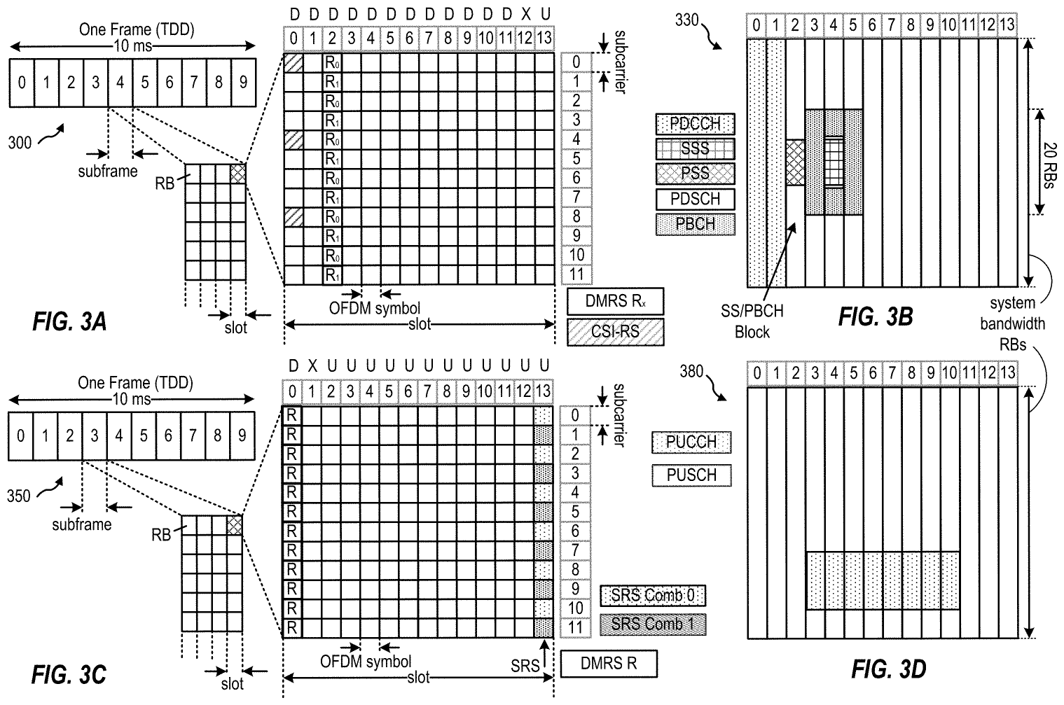

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

### Aspects Related to Coordinated Tune Away for Multi-SIM Devices

In certain cases, two different subscriptions may be supported on a same device, such as a user equipment (UE), and may be associated with two separate subscriber identification module (SIMs), known as multi-SIM. These subscriptions may be associated with the same radio network or different radio access networks (RANs). Additionally, these subscriptions may have different subscription profiles and quality of service (QoS) requirements. Further, different subscriptions may provide services on the same or different radio access technologies (RATs). For example, in some cases, a first subscription and a second subscription may both provide services on a fifth generation (5G) new radio (NR) RAT (e.g., in some cases in different 5G NR networks) or the first subscription may provide services on a fourth generation (4G) long term evolution (LTE) RAT and the second subscription may provide services on the 5G NR RAT. Generally, multi-SIM solutions use less resources while performing operations on two different RATs than that needed by two independent solutions with the goal of optimizing resource (e.g., radio frequency (RF), million of instructions per second (MIPS), etc.) usage as well as providing enhanced user experience.

Different classes of RF solutions exist for communication by multi-SIM devices. For example, in some cases, the multi-SIM device may include a dual transceiver that may provide dual receive and dual access (DSDA). In this case, each subscription may correspond to a different transceiver. In other cases, the multi-SIM device may include a single transceiver where two subscriptions share the same radio resources/receive chain. Due to RF complexity, cost, and power consumption considerations, the majority of legacy dual subscription devices and solutions share a single transceiver and the same receive chain. As a consequence, in certain cases, the multi-SIM device (e.g., user equipment (UE)) may have to suspend a first subscription and tune away (e.g., re-tune one or more receive chains) to allow a the UE to perform one or more actions associated with a second subscription, such as receiving paging, performing measurement activity, and the like.

For example, in the context of multi-SIM, when the first subscription comprises a default data subscription (DDS) and is in an active data call or data session/transfer in a connected mode, base band resources may be shared with an idle mode non-DDS second subscription for paging occasions associated with the second subscription via tune away gaps. These tune away gaps are generally a period of time in which the UE tunes away from the DDS first subscription to receive a paging message in one or more paging occasions associated with the non-DDS second subscription. These paging occasions associated with the non-DDS second subscription are often periodic and typically tied to a discontinuous reception (DRX) cycle length of the idle mode associated with the second subscription.

In some cases, both the first subscription and the second subscription may be associated with a different standalone networks (e.g., SA+SA). A standalone network is generally a network in which all signalling, and mobility management are handled by a core network entity of that network. For example, in cases of a standalone 5G NR network, all signalling and mobility management are handled by a 5G core network entity (e.g., as opposed to a non-standalone architecture in which control signalling for the 5G NR network may be anchored in a 4G core network entity).

In cases where the first subscription and the second subscription are associated with different standalone networks, the tune away gaps associated with the DDS first subscription may involve one or more radio frequency (RF) receiver chains outage periods associated with the first subscription. During these outage periods, the UE may retune the one or more RF receiver chains from a first RAN associated with the first subscription to a second RAN associated with the second subscription.

However, there may be situations where the n-DDS idle mode second subscription is required to perform a tune away involving one or more base-band resource outage periods associated with the first subscription, for one or more actions associated with the second subscription. In some cases, the one or more actions associated with the second subscription that may lead to the base-band resource outage periods associated with the first subscription may include activities that occur less frequently than, for example, paging, and are not periodical. For example, the one or more actions associated with the second subscription may include activities related to a system information block (SIB) decode, one or more activities related to sending or receiving short message service (SMS) messages, one or more actions related to recovering from an out-of-service (OOS) indication, one or more actions related to cell reselection, intra-frequency cell measurements, or inter-frequency cell measurements, or inter-radio access technology (RAT) cell measurements.

Currently, there may not be procedure for a multi-SIM device (e.g. UE) to notify the first RAN associated with the first subscription when the multi-SIM device autonomously leaves (e.g., tunes away) or releases a radio resource control (RRC) connection with the first RAN. In some cases, this autonomously tuning away and RRC connection release may be interpreted by the first RAN as an error and has the potential to distort statistics in the first RAN and misguide the algorithms, such as downlink or uplink scheduling algorithms or synchronization algorithms, that rely on these statistics. Moreover, resources in the first RAN may be wasted during the absence of the multi-SIM device from the first RAN since the multi-SIM device may not be able to receive downlink data or process paging from the first RAN during the absence of the multi-SIM device.

Thus, aspects of the present disclosure provide techniques for enabling a multi-SIM device to leave or tune away from a RAN, such as a standalone first RAN associated with a DDS subscription, while avoiding the wasting of resources in the first RAN. In some cases, such techniques may involve a coordinated tune away that includes enabling a connected mode DDS subscription to inform a base station of the first RAN about an upcoming tune away gap and requesting the base station to suspend one or more actions associated with the DDS subscription. For example, in some cases, the multi-SIM device may request the base station of the first RAN to suspend certain activities, such as suspending the transmission of uplink/downlink grants or suspending bandwidth part (BWP) switching. Accordingly, by suspending the one or more actions associated with the DDS subscription during a tune away, the multi-SIM device is free to tune away to perform one or more actions associated with another subscription (e.g., a non-DDS subscription) in a second RAN without missing signalling from the first RAN, which would otherwise lead to wasted resources in the first RAN.

### Example Call Flow for Communicating Based on a Coordinated Tune Away

FIG. 4 is a call flow diagram illustrating example operations 400 between a first base station (BS) 402, a UE 404, and a second BS 406 for communicating based on a coordinated tune away. In some cases, the first BS 402 may be an example of the BS 102 in the wireless communication network 100 illustrated in FIG. 1. In some cases, the first BS 402 may be associated with a first RAN. The first RAN may include, for example, a standalone RAN, such as a 5G NR RAN or any other suitable standalone RAN. Similarly, the second BS406 may be associated with a second RAN, which may also be a standalone RAN, such as a 5G NR RAN or any other suitable standalone RAN. Additionally, the UE 404 may be an example of the UE 104 illustrated in FIG. 1. Further, as shown, a Uu interface may be established to facilitate communication between the first BS 402 and UE 404, however, in other aspects, a different type of interface may be used. Likewise, as shown, a Uu interface may be established to facilitate communication between the second BS 406 and UE 404, however, in other aspects, a different type of interface may be used.

Operations 400 begin at 410 with the UE 404 communicating with the first BS 402 of the first RAN. Additionally, at 420, the UE 404 may also communicate with the second BS 406. In some cases, communicating with the first BS 402 and the second BS 406 may include any type of downlink or uplink signalling communicated between the first BS 402 and the UE 404 and between the second BS 406 and the UE 404. For example, communicating with the first BS 402 may include establishing a connection with the first BS 402 and communicating with the second BS 406 may include establishing a connection with the second BS 406. In some cases, the UE 404 may include a first subscription associated with a first subscriber identity module (SIM) of the UE for communicating with the first BS 402 of the first RAN. The UE 404 may also include a second subscription associated with a second SIM of the UE for communicating with the second BS 406 of the second RAN. In some cases, the first subscription comprises a default data subscription (DDS) and the second subscription comprises a non-default data subscription (n-DDS).

In some cases, communicating with the first BS 402 via the first subscription and the second BS 406 via the second subscription may not be simultaneous. For example, in some cases, the UE 404 may include only a single transceiver where the first subscription and the second subscription share the same RF chains of the transceiver for transmitting and receiving signals. As a result, communication with the first BS 402 and the second BS 406 may be facilitated by tune away gaps. These tune away gaps may include the UE 404 selectively tuning one or more RF chains from, for example, communicating with the first BS 402 of the first RAN via the first subscription to communicating with the second BS 406 of the second RAN via the second subscription or vice versa, as described above.

In some cases, because the first subscription is a DDS subscription, the UE 404 may, by default, tune the one or more RF chains to the first BS 402 of the first RAN. To facilitate communication with the second BS 406 of the second RAN using the second subscription, the UE 404 may, for a period of time, retune the one or more RF chains from the first BS 402 of the first RAN to the second BS 406 of the second RAN, thereafter returning the one or more RF chains back to the first BS of the first RAN.

In some cases, because the UE 404 may not be capable of simultaneous communication, the UE 404 may operate in two different operating modes associated with the first subscription and second subscription. For example, in some cases, the UE 404 may communicate with the first BS 402 of the first RAN using the first subscription while operating in a connected mode. However, during the communication with the first BS 402 using the first subscription, the UE 404 may operate in an idle mode associated with the second subscription.

The operations 400 continue at 430 with the UE 404 detecting a tune away associated with the first RAN will occur to allow the UE 404 to perform one or more first actions associated with the second subscription. In some cases, the tune away associated with the first RAN may include a tune away that comprises one or more base-band resource outage periods associated with the first subscription. In some cases, the tune away associated with the first RAN may include a tune away that comprises RF receiver chains outage periods associated with the first subscription.

In some cases, the one or more first actions associated with the second subscription that may be performed by the UE 404 during the detected tune away may comprise one or more non-periodic actions. For example, the one or more non-periodic actions associated with the second subscription may include actions, such as a SIB decode, one or more activities related to sending or receiving SMS messages, one or more actions related to recovering from an 00S indication, one or more actions related to cell reselection, intra-frequency cell measurements, inter-frequency cell measurements, or inter-RAT cell measurements.

In response to detecting the tune away associated with the first RAN, the UE 404 transmits information, to the first BS of the first RAN at 440, indicating the tune away associated with the first RAN. In some cases, the information may be transmitted to the first BS of the first RAN prior to the tune away and may include at least one request to suspend one or more second actions associated with the first subscription. In some cases, the information may be transmitted by the UE 404 to the first BS 402 in media access control control element (MAC-CE).

In some cases, when the tune away is associated with one or more base-band resource outage periods associated with the first subscription, the at least one request to suspend one or more second actions associated with the first subscription comprises a request for the first BS 402 of the first RAN to suspend transmissions of uplink and downlink grants on all activated component carriers (CCs) associated with the first subscription, including a primary component carrier (PCC).

In some cases, when the tune away is associated with one or more base-band resource outage periods associated with the first subscription, the at least one request to suspend one or more second actions associated with the first subscription comprises a request for the first BS 402 of the first RAN to suspend any upcoming BWP switching on all activated carriers associated with the first subscription.

In some cases, when the tune away is associated with one or more RF receiver chains outage periods associated with the first subscription, the at least one request to suspend one or more second actions associated with the first subscription comprises a request for the first BS of the first RAN to suspend transmissions of uplink and downlink grants on all or a selected set of activated component carriers associated with the first subscription except for the PCC associated with the first subscription.

In some cases, when the tune away is associated with one or more RF receiver chains outage periods associated with the first subscription, the at least one request to suspend one or more second actions associated with the first subscription comprises a request for the first BS of the first RAN to suspend any upcoming BWP switching on all or a selected set of activated component carriers associated with the first subscription except for the PCC associated with the first subscription.

As illustrated at 450, in response to receiving the information from the UE 404, the first BS 402 suspends the one or more second actions associated with the first subscription. For example, as noted above, in some cases, depending on the tune away, the first BS 402 may suspend transmitting uplink and downlink grants on all or selected a selected set of activated CCs associated with first subscription including the PCC associated with the first subscription. In some cases, the first BS 402 suspends BWP switching on all activated carriers associated with the first subscription. In some cases, the first BS 402 may suspend transmitting uplink and downlink grants on all or a selected set of activated CCs associated with first subscription except for the PCC associated with the first subscription.

As illustrated at 460, the UE 404 performs a tune away by tuning one or more RF chains from the first BS of the first RAN to the second BS of the second RAN. During the tune away, the UE 404 performs the one or more first actions associated with the second RAN. For example, as illustrated at 470 in FIG. 4, the UE 404 receives and decodes a SIB from the second BS 406 of the second RAN via the second subscription. Receiving and decoding a SIB from the second BS 406 of the second RAN is just one example of an action that may be performed by the UE 404 associated with the second RAN. As noted above, the one or more first actions may also include actions, such as one or more activities related to sending or receiving short message service (SMS) messages, one or more actions related to recovering from an 00S indication, one or more actions related to cell reselection, intra-frequency cell measurements, inter-frequency cell measurements, or inter-RAT cell measurements.

After performing the one or more first actions associated with the second RAN, the UE 404 may retune the one or more RF chains back to the first BS of the first RAN. The UE 404 may then transmit additional information to the first BS of the first RAN, indicating that the tune away has been completed. The additional information may also include a request to resume the one or more second actions associated with the first subscription. For example, the additional information may include a request to resume transmission of at least one of uplink grants or downlink grants associated with the first subscription. In some cases, the UE may request to resume the transmission of the uplink or downlink grants by transmitting a scheduling request (SR) to the first BS 402 of the first RAN. In other words, the additional information transmitted by the UE 404 to the first BS 402 may comprise an SR associated with the first subscription that requests resources for communicating with the first BS 402 of the first RAN. In some cases, the additional information may be transmitted in a MAC-CE to the first BS 402.

Thereafter, as shown at 490, the first BS 402 of the first RAN may resume performing the one or more second actions, such as resuming transmission of the uplink or downlink grants and/or resuming BWP switching. In some cases, the first BS 402 of the first RAN may resume performing the one or more second actions based on the request in the additional information.

In other cases, the first BS 402 of the first RAN may resume performing the one or more second actions based on an expected duration of the tune away. For example, in some cases, the UE 404 may include an indication of an expected duration of the tune away associated with the first RAN within the information transmitted to the first BS 402 at 440 in FIG. 4. The expected duration of the tune away provides an indication to the first BS 402 to resume the one or more second actions associated with the first subscription at 490 after the expected duration of the tune away. For example, upon receiving the indication of the tune away and the expected duration of the tune away, the first BS 402 may set a timer to the expected duration of the tune away and suspend the one or more second actions at 450 while the timer is running. Thereafter, once the timer expires, the first BS 402 may resume performing the one or more second actions at 490. In some cases, when resuming the performance of the one or more second actions at 490 based on the expected duration of the tune away, it may not be necessary for the UE 404 to transmit the additional information at 480 indicating the tune away has been completed and the request to resume the one or more second actions.

### Example Methods for Coordinated Tune Away for Multi-SIM Devices

FIG. 5 is a flow diagram illustrating example operations 500 for wireless communication, in accordance with certain aspects of the present disclosure. The operations 500 may be performed, for example, by a UE (e.g., such as the UE 104 in the wireless communication network 100 of FIG. 1) for coordinated tune away for multi-SIM devices. The operations 500 may be implemented as software components that are executed and run on one or more processors (e.g., controller/processor 280 of FIG. 2). Further, the transmission and reception of signals by the UE in operations 500 may be enabled, for example, by one or more antennas (e.g., antennas 252 of FIG. 2). In certain aspects, the transmission and/or reception of signals by the UE may be implemented via a bus interface of one or more processors (e.g., controller/processor 280, including the tune away component 281) obtaining and/or outputting signals.

Operations 500 begin at 510 with communicating with a first base station (BS) of a first radio access network (RAN) in a connected mode using a first subscription associated with a first subscriber identity module (SIM) of the UE. In some cases, the UE includes a second subscription associated with a second SIM for communicating with a second BS of a second RAN and the UE operates in an idle mode associated with the second subscription while communicating with the BS using the first subscription in the connected mode.

In block 520, the UE determines a tune away associated with the first RAN will occur to allow the UE to perform one or more first actions associated with the second subscription.

In block 530, the UE transmits, prior to the tune away, information to the first BS of the first RAN indicating the tune away and at least one request to suspend one or more second actions associated with the first subscription.

In some cases, the first subscription comprises a default data subscription (DDS) and the second subscription comprises a non-default data subscription (n-DDS).

In some cases, the one or more first actions associated with the second subscription comprise one or more non-periodic actions. In some cases, the one or more non-periodic actions comprise at least one of: a system information block (SIB) decode, one or more activities related to sending or receiving short message service (SMS) messages, one or more actions related to recovering from an out-of-service (OOS) indication, one or more actions related to cell reselection, or intra-frequency cell measurements, or inter-frequency cell measurements, or inter-radio access technology (RAT) cell measurements.

In some cases, when the tune away is associated with one or more base-band resource outage periods associated with the first subscription, the at least one request to suspend one or more second actions associated with the first subscription comprises a request for the first BS of the first RAN to suspend transmissions of uplink and downlink grants on all activated component carriers associated with the first subscription.

In some cases, when the tune away is associated with one or more base-band resource outage periods associated with the first subscription, the at least one request to suspend one or more second actions associated with the first subscription comprises a request for the first BS of the first RAN to suspend any upcoming bandwidth part switching on all activated carriers associated with the first subscription.

In some cases, when the tune away is associated with one or more radio frequency (RF) receiver chains outage periods associated with the first subscription, the at least one request to suspend one or more second actions associated with the first subscription comprises at least one of: a request for the first BS of the first RAN to suspend transmissions of uplink and downlink grants on all or a selected set of activated component carriers associated with the first subscription except a primary component carrier associated with the first subscription or a request for the first BS of the first RAN to suspend any upcoming bandwidth part switching on all or a selected set of activated component carriers associated with the first subscription except for a primary component carrier associated with the first subscription.

In some cases, transmitting the information to the first BS of the first RAN indicating the tune away comprises transmitting the information to the first BS of the first RAN indicating the tune away in a media access control control element (MAC-CE).

In some cases, the operations 500 further include transmitting additional information to the first BS of the first RAN, after performing the one or more first actions associated with the second RAN, indicating that the tune away has been completed and a request to resume the one or more second actions associated with the first subscription. In some cases, the additional information may include a scheduling request (SR) associated with the first subscription. In some cases, the request to resume the one or more second actions associated with the first subscription includes a request to resume transmission of at least one of uplink grants or downlink grants associated with the first subscription. In some cases, transmitting the additional information to the first BS of the first RAN comprises transmitting the additional information to the first BS of the first RAN in a media access control control element (MAC-CE).

In some cases, the information indicating the tune away further includes an expected duration of the tune away associated with the first RAN. In some cases, the expected duration of the tune away provides an indication to resume the one or more second actions associated with the first subscription after the duration of the tune away.

In some cases, operations 500 further include performing the tune away associated with the first RAN to perform the one or more first actions associated with the second subscription. In such cases, during the tune away, the UE operates in an idle mode associated with the first subscription and a connected mode associated with the second subscription.

FIG. 6 is a flow diagram illustrating example operations 600 for wireless communication. The operations 600 may be performed, for example, by a BS (e.g., such as the BS 102 in the wireless communication network 100 of FIG. 1) of a first RAN for coordinated tune away for multi-SIM devices. In some cases, operations 600 may be complementary to operations 400 performed by the UE in FIG. 5. The operations 600 may be implemented as software components that are executed and run on one or more processors (e.g., controller/processor 240 of FIG. 2). Further, the transmission and reception of signals by the BS in operations 600 may be enabled, for example, by one or more antennas (e.g., antennas 234 of FIG. 2). In certain aspects, the transmission and/or reception of signals by the BS may be implemented via a bus interface of one or more processors (e.g., controller/processor 240, including the tune away component 241) obtaining and/or outputting signals.

The operations 600 begin at 610 with communicating with a user equipment (US) in a connected mode using a first subscription associated with a first subscriber identity module (SIM) of the UE.

In block 620, the BS receives information from the UE indicating that a tune away associated with the first RAN will occur to allow the UE to perform one or more first actions associated with a second subscription of the UE associated with a second SIM. In some cases the information includes at least one request to suspend one or more second actions associated with the first subscription. Additionally, in some cases, receiving the information indicating that the tune away associated with the first RAN will occur comprises receiving the information prior to the tune away.

In block 630, the BS suspends the one or more second actions associated with the first subscription during the tune away.

In some cases, the first subscription comprises a default data subscription (DDS) and the second subscription comprises a non-default data subscription (n-DDS).

In some cases, the one or more first actions associated with the second subscription comprise one or more non-periodic actions. For example, in some cases, the one or more non-periodic actions comprise at least one of: a system information block (SIB) decode, one or more activities related to sending or receiving short message service (SMS) messages, one or more actions related to recovering from an out-of-service (OOS) indication, one or more actions related to cell reselection, intra-frequency cell measurements, or inter-frequency cell measurements, or inter-radio access technology (RAT) cell measurements.

In some cases, when the tune away is associated with one or more base-band resource outage periods associated with the first subscription, the at least one request to suspend one or more second actions associated with the first subscription comprises a request for the first BS of the first RAN to suspend transmissions of uplink and downlink grants on all activated component carriers associated with the first subscription. In such cases, suspending the one or more second actions associated with the first subscription during the tune away comprises suspending the transmissions of the uplink and downlink grants on all the activated component carriers associated with the first subscription during the tune away.

In some cases, when the tune away is associated with one or more base-band resource outage periods associated with the first subscription, the at least one request to suspend one or more second actions associated with the first subscription comprises a request for the first BS of the first RAN to suspend any upcoming bandwidth part switching on all activated carriers associated with the first subscription. In such cases, suspending the one or more second actions associated with the first subscription during the tune away comprises suspending the upcoming bandwidth part switching on all the activated carriers associated with the first subscription.

In some cases, when the tune away is associated with one or more radio frequency (RF) receiver chains outage periods associated with the first subscription, the at least one request to suspend one or more second actions associated with the first subscription comprises at least one of: a request for the first BS of the first RAN to suspend transmissions of uplink and downlink grants on all or a selected set of activated component carriers associated with the first subscription except a primary component carrier associated with the first subscription or a request for the first BS of the first RAN to suspend any upcoming bandwidth part switching on all or a selected set of activated component carriers associated with the first subscription except for a primary component carrier associated with the first subscription. In such cases, suspending the one or more second actions associated with the first subscription during the tune away comprises at least one of: suspending the transmissions of the uplink and downlink grants on all or the selected set of activated component carriers associated with the first subscription except the primary component carrier associated with the first subscription or suspending any upcoming bandwidth part switching on all or a selected set of activated component carriers associated with the first subscription except for a primary component carrier associated with the first subscription.

In some cases, receiving the information indicating the tune away comprises receiving the information indicating the tune away in a media access control control element (MAC-CE).

In some cases, operations 600 further include receiving additional information from the UE indicating that the tune away has been completed and a request to resume the one or more second actions associated with the first subscription and resuming the one or more second actions associated with the first subscription based on the request to resume the one or more second actions associated with the first subscription. In some cases, the request to resume the one or more second actions associated with the first subscription includes a request to resume transmission of at least one of uplink grants or downlink grants associated with the first subscription. In such cases, resuming the one or more second actions associated with the first subscription comprises resuming transmission of at least one of uplink grants or downlink grants associated with the first subscription. In some cases, receiving the additional information comprises receiving the additional information in a media access control control element (MAC-CE).

In some cases, the information indicating the tune away further includes an expected duration of the tune away associated with the first RAN. In some cases, the expected duration of the tune away provides an indication to resume the one or more second actions associated with the first subscription after the expected duration of the tune away.

In some cases, resuming the one or more second actions associated with the first subscription after the expected duration of the tune away.

### Example Wireless Communication Devices

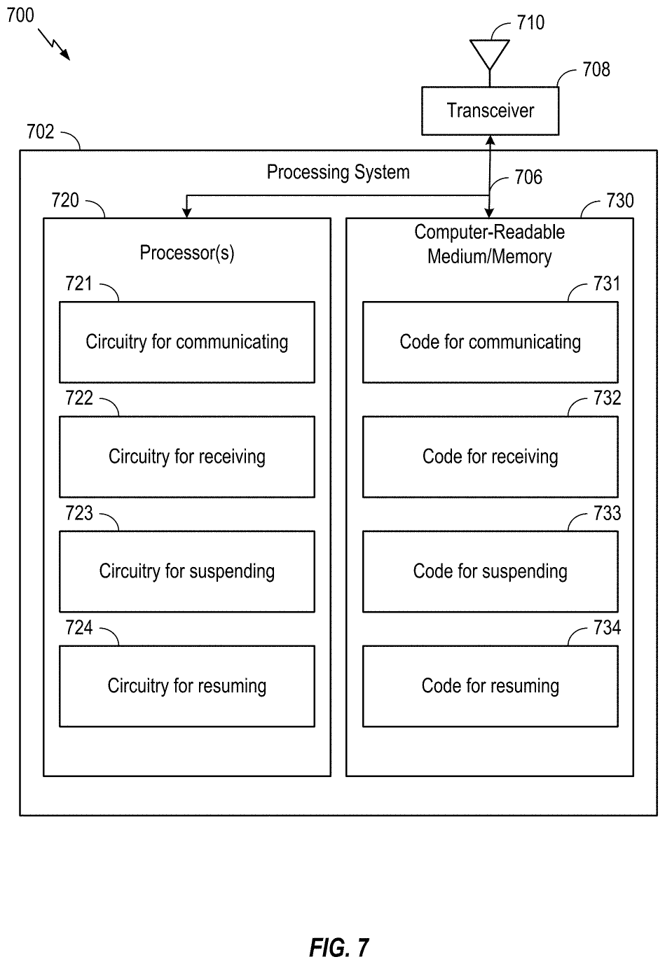

FIG. 7 depicts an example communications device 700 that includes various components operable, configured, or adapted to perform operations for the techniques disclosed herein, such as the operations depicted and described with respect to FIGS. 4 and 7. In some examples, communication device 700 may be a base station 102 as described, for example with respect to FIGS. 1 and 2.

Communications device 700 includes a processing system 702 coupled to a transceiver 708 (e.g., a transmitter and/or a receiver). Transceiver 708 is configured to transmit (or send) and receive signals for the communications device 700 via an antenna 710, such as the various signals as described herein. Processing system 702 may be configured to perform processing functions for communications device 700, including processing signals received and/or to be transmitted by communications device 700.

Processing system 702 includes one or more processors 720 coupled to a computer-readable medium/memory 730 via a bus 706. In certain aspects, computer-readable medium/memory 730 is configured to store instructions (e.g., computer-executable code) that when executed by the one or more processors 720, cause the one or more processors 720 to perform the operations illustrated in FIGS. 4 and 6, as well as other operations for performing the various techniques discussed herein for coordinated tune away for multi-SIM devices.

In the depicted example, computer-readable medium/memory 730 stores code 731 for communicating, code 732 for receiving, code 733 for suspending, and code 734 for resuming.

In the depicted example, the one or more processors 720 include circuitry configured to implement the code stored in the computer-readable medium/memory 730, including circuitry 721 for communicating, circuitry 722 for receiving, circuitry 723 for suspending, and circuitry 724 for resuming.

Various components of communications device 700 may provide means for performing the methods described herein, including with respect to FIGS. 4 and 6.

In some examples, means for transmitting or sending (or means for outputting for transmission), as well as means for communicating, may include the transceivers 232 and/or antenna(s) 234 of the base station 102 illustrated in FIG. 2 and/or transceiver 708 and antenna 710 of the communication device 700 in FIG. 7.

In some examples, means for receiving (or means for obtaining), as well as means for communicating, may include the transceivers 232 and/or antenna(s) 234 of the base station illustrated in FIG. 2 and/or transceiver 708 and antenna 710 of the communication device 700 in FIG. 7.

In some examples, means for suspending and means for resuming may include various processing system components, such as the one or more processors 720 in FIG. 7, or aspects of the base station 102 depicted in FIG. 2, including receive processor 238, transmit processor 220, TX MIMO processor 230, and/or controller/processor 240 (including tune away component 241).

Notably, FIG. 7 is just one example, and many other examples and configurations of communication device 700 are possible.

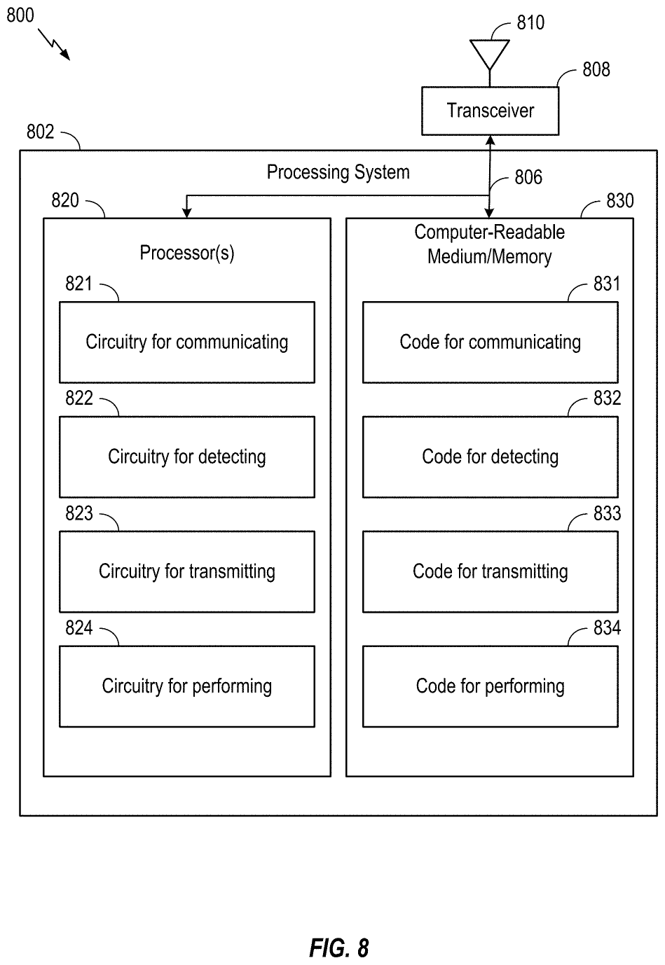

FIG. 8 depicts an example communications device 800 that includes various components operable, configured, or adapted to perform operations for the techniques disclosed herein, such as the operations depicted and described with respect to FIGS. 4 and 5. In some examples, communication device 800 may be a user equipment 104 as described, for example with respect to FIGS. 1 and 2.

Communications device 800 includes a processing system 802 coupled to a transceiver 808 (e.g., a transmitter and/or a receiver). Transceiver 808 is configured to transmit (or send) and receive signals for the communications device 800 via an antenna 810, such as the various signals as described herein. Processing system 802 may be configured to perform processing functions for communications device 800, including processing signals received and/or to be transmitted by communications device 800.

Processing system 802 includes one or more processors 820 coupled to a computer-readable medium/memory 830 via a bus 806. In certain aspects, computer-readable medium/memory 830 is configured to store instructions (e.g., computer-executable code) that when executed by the one or more processors 820, cause the one or more processors 820 to perform the operations illustrated in FIGS. 4 and 5, as well as other operations for performing the various techniques discussed herein for coordinated tune away for multi-SIM devices.

In the depicted example, computer-readable medium/memory 830 stores code 831 for communicating, code 832 for detecting, code 833 for transmitting, and code 834 for performing

In the depicted example, the one or more processors 820 include circuitry configured to implement the code stored in the computer-readable medium/memory 830, including circuitry 821 for communicating, circuitry 822 for detecting, circuitry 823 for transmitting, and circuitry 824 for performing

Various components of communications device 800 may provide means for performing the methods described herein, including with respect to FIGS. 4 and 5.

In some examples, means for transmitting or sending (or means for outputting for transmission), as well as means for communicating, may include the transceivers 254 and/or antenna(s) 252 of the user equipment 104 illustrated in FIG. 2 and/or transceiver 808 and antenna 810 of the communication device 800 in FIG. 8.

In some examples, means for receiving (or means for obtaining), as well as means for communicating, may include the transceivers 254 and/or antenna(s) 252 of the user equipment 104 illustrated in FIG. 2 and/or transceiver 808 and antenna 810 of the communication device 800 in FIG. 8.

In some examples, means for detecting and means for performing may include various processing system components, such as the one or more processors 820 in FIG. 8, or aspects of the user equipment 104 depicted in FIG. 2, including receive processor 258, transmit processor 264, TX MIMO processor 266, and/or controller/processor 280 (including tune away component 281).

Notably, FIG. 8 is just one example, and many other examples and configurations of communication device 800 are possible.

### Example Clauses

Implementation examples are described in the following numbered clauses:

Clause 1: A method for wireless communication by a user equipment (UE), comprising: communicating with a first base station (BS) of a first radio access network (RAN) in a connected mode using a first subscription associated with a first subscriber identity module (SIM) of the UE, wherein: the UE includes a second subscription associated with a second SIM for communicating with a second BS of a second RAN, and the UE operates in an idle mode associated with the second subscription while communicating with the BS using the first subscription in the connected mode; determining a tune away associated with the first RAN will occur to allow the UE to perform one or more first actions associated with the second subscription; and transmitting, prior to the tune away, information to the first BS of the first RAN indicating the tune away and at least one request to suspend one or more second actions associated with the first subscription.

Clause 2: The method of Clause 1, wherein the first subscription comprises a default data subscription (DDS) and the second subscription comprises a non-default data subscription (n-DDS).

Clause 3: The method of any one of Clauses 1-2, wherein the one or more first actions associated with the second subscription comprise one or more non-periodic actions.

Clause 4: The method of any one of Clauses 1-3, wherein the one or more non-periodic actions comprise at least one of: a system information block (SIB) decode, one or more activities related to sending or receiving short message service (SMS) messages, one or more actions related to recovering from an out-of-service (OOS) indication, one or more actions related to cell reselection, intra-frequency cell measurements, inter-frequency cell measurements, or inter-radio access technology (RAT) cell measurements.

Clause 5: The method of any one of Clauses 1-4, wherein, when the tune away is associated with one or more base-band resource outage periods associated with the first subscription, the at least one request to suspend one or more second actions associated with the first subscription comprises a request for the first BS of the first RAN to suspend transmissions of uplink and downlink grants on all activated component carriers associated with the first subscription.

Clause 6: The method of any one of Clauses 1-5, wherein, when the tune away is associated with one or more base-band resource outage periods associated with the first subscription, the at least one request to suspend one or more second actions associated with the first subscription comprises a request for the first BS of the first RAN to suspend any upcoming bandwidth part switching on all activated carriers associated with the first subscription.

Clause 7: The method of any one of Clauses 1-6, wherein, when the tune away is associated with one or more RF receiver chains outage periods associated with the first subscription, the at least one request to suspend one or more second actions associated with the first subscription comprises at least one of: a request for the first BS of the first RAN to suspend transmissions of uplink and downlink grants on all or a selected set of activated component carriers associated with the first subscription except a primary component carrier associated with the first subscription or a request for the first BS of the first RAN to suspend any upcoming bandwidth part switching on all or a selected set of activated component carriers associated with the first subscription except for a primary component carrier associated with the first subscription.

Clause 8: The method of any one of Clauses 1-7, wherein transmitting the information to the first BS of the first RAN indicating the tune away comprises transmitting the information to the first BS of the first RAN indicating the tune away in a media access control control element (MAC-CE).

Clause 9: The method of any one of Clauses 1-8, further comprising transmitting additional information to the first BS of the first RAN, after performing the one or more first actions associated with the second RAN, indicating that the tune away has been completed and a request to resume the one or more second actions associated with the first subscription.

Clause 10: The method of Clause 9, wherein the request to resume the one or more second actions associated with the first subscription includes a request to resume transmission of at least one of uplink grants or downlink grants associated with the first subscription.

Clause 11: The method of any one of Clauses 9-10, wherein the additional information comprises a scheduling request (SR) associated with the first subscription.

Clause 12: The method of any one of Clauses 9-11, wherein transmitting the additional information to the first BS of the first RAN comprises transmitting the additional information to the first BS of the first RAN in a media access control control element (MAC-CE).

Clause 13: The method of any one of Clauses 1-12, wherein the information indicating the tune away further includes an expected duration of the tune away associated with the first RAN.

Clause 14: The method of Clause 13, wherein the expected duration of the tune away provides an indication to resume the one or more second actions associated with the first subscription after the expected duration of the tune away.

Clause 15: The method of any one of Clauses 1-14, further comprising performing the tune away associated with the first subscription to perform the one or more first actions associated with the second subscription, wherein, during the tune away, the UE operates in an idle mode associated with the first subscription and a connected mode associated with the second subscription.

Clause 16: A method for wireless communication by a first base station (BS) of a first radio access network (RAN), comprising: communicating with a user equipment (US) in a connected mode using a first subscription associated with a first subscriber identity module (SIM) of the UE; receiving information from the UE indicating that a tune away associated with the first RAN will occur to allow the UE to perform one or more first actions associated with a second subscription of the UE associated with a second SIM, wherein: the information includes at least one request to suspend one or more second actions associated with the first subscription, and receiving the information indicating that the tune away associated with the first RAN will occur comprises receiving the information prior to the tune away; and suspending the one or more second actions associated with the first subscription during the tune away.

Clause 17: The method of Clause 16, wherein the first subscription comprises a default data subscription (DDS) and the second subscription comprises a non-default data subscription (n-DDS).

Clause 18: The method of any one of Clauses 16-17, wherein the one or more first actions associated with the second subscription comprise one or more non-periodic actions.

Clause 19: The method of any one of Clauses 16-18, wherein the one or more non-periodic actions comprise at least one of: a system information block (SIB) decode, one or more actions related to recovering from an out-of-service (OOS) indication, one or more activities related to sending receiving short message service (SMS) messages, one or more actions related to cell reselection, intra-frequency cell measurements, inter-frequency cell measurements, or inter-radio access technology (RAT) cell measurements.

Clause 20: The method of any one of Clauses 16-19, wherein: when the tune away is associated with one or more base-band resource outage periods associated with the first subscription, the at least one request to suspend one or more second actions associated with the first subscription comprises a request for the first BS of the first RAN to suspend transmissions of uplink and downlink grants on all activated component carriers associated with the first subscription, and suspending the one or more second actions associated with the first subscription during the tune away comprises suspending the transmissions of the uplink and downlink grants on all the activated component carriers associated with the first subscription during the tune away.

Clause 21: The method of any one of Clauses 16-20, wherein: when the tune away is associated with one or more base-band resource outage periods associated with the first subscription, the at least one request to suspend one or more second actions associated with the first subscription comprises a request for the first BS of the first RAN to suspend any upcoming bandwidth part switching on all activated carriers associated with the first subscription, and suspending the one or more second actions associated with the first subscription during the tune away comprises suspending the upcoming bandwidth part switching on all the activated carriers associated with the first subscription.

Clause 22: The method of any one of Clauses 16-22, wherein: when the tune away is associated with one or more radio frequency (RF) receiver chains outage periods associated with the first subscription, the at least one request to suspend one or more second actions associated with the first subscription comprises at least one of: a request for the first BS of the first RAN to suspend transmissions of uplink and downlink grants on all or a selected set of activated component carriers associated with the first subscription except a primary component carrier associated with the first subscription or a request for the first BS of the first RAN to suspend any upcoming bandwidth part switching on all or a selected set of activated component carriers associated with the first subscription except for a primary component carrier associated with the first subscription, and suspending the one or more second actions associated with the first subscription during the tune away comprises at least one of: suspending the transmissions of the uplink and downlink grants on all or the selected set of activated component carriers associated with the first subscription except the primary component carrier associated with the first subscription or a request for the first BS of the first RAN to suspending any of the upcoming bandwidth part switching on all or the selected set of activated component carriers associated with the first subscription except for the primary component carrier associated with the first subscription.

Clause 23: The method of any one of Clauses 16-22, wherein receiving the information indicating the tune away comprises receiving the information indicating the tune away in a media access control control element (MAC-CE).

Clause 24: The method of any one of Clauses 16-23, further comprising: receiving additional information from the UE indicating that the tune away has been completed and a request to resume the one or more second actions associated with the first subscription; and resuming the one or more second actions associated with the first subscription based on the request to resume the one or more second actions associated with the first subscription.

Clause 25: The method of Clause 24, wherein: the request to resume the one or more second actions associated with the first subscription includes a request to resume transmission of at least one of uplink grants or downlink grants associated with the first subscription, and resuming the one or more second actions associated with the first subscription comprises resuming transmission of at least one of uplink grants or downlink grants associated with the first subscription.

Clause 26: The method of any one of Clauses 24-25, wherein receiving the additional information comprises receiving the additional information in a media access control control element (MAC-CE).

Clause 27: The method of any one of Clauses 24-26, wherein the additional information comprises a scheduling request (SR) associated with the first subscription.

Clause 28: The method of any one of Clauses 16-27, wherein the information indicating the tune away further includes an expected duration of the tune away associated with the first RAN.

Clause 29: The method of Clause 28, wherein the expected duration of the tune away provides an indication to resume the one or more second actions associated with the first subscription after the expected duration of the tune away.

Clause 30: The method of Clause 29, further comprising resuming the one or more second actions associated with the first subscription after the expected duration of the tune away.

Clause 31: An apparatus, comprising: a memory comprising executable instructions; and one or more processors configured to execute the executable instructions and cause the apparatus to perform a method in accordance with any one of Clauses 1-30.

Clause 32: An apparatus, comprising means for performing a method in accordance with any one of Clauses 1-31.

Clause 33: A non-transitory computer-readable medium comprising executable instructions that, when executed by one or more processors of an apparatus, cause the apparatus to perform a method in accordance with any one of Clauses 1-30.

Clause 34: A computer program product embodied on a computer-readable storage medium comprising code for performing a method in accordance with any one of Clauses 1-30.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mmWave frequencies, the gNB 180 may be referred to as an mmWave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communication network 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signalling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signalling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signalling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of coordinated tune away for multi-SIM devices in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user equipment (UE) for wireless communication, comprising:
a memory comprising executable instructions; and
one or more processors configured to execute the executable instructions and cause the UE to:
communicate with a first base station (BS) of a first radio access network (RAN) in a connected mode using a first subscription associated with a first subscriber identity module (SIM) of the UE, wherein:
the UE includes a second subscription associated with a second SIM for communicating with a second BS of a second RAN, and
the UE operates in an idle mode associated with the second subscription while communicating with the BS using the first subscription in the connected mode;
determine a tune away associated with the first RAN will occur to allow the UE to perform one or more first actions associated with the second subscription; and
transmit, prior to the tune away, information to the first BS of the first RAN indicating the tune away and at least one request to suspend one or more second actions associated with the first subscription.

2. The UE of claim 1, wherein the first subscription comprises a default data subscription (DDS) and the second subscription comprises a non-default data subscription (n-DDS).

3. The UE of claim 1, wherein the one or more first actions associated with the second subscription comprise one or more non-periodic actions.

4. The UE of claim 1, wherein the one or more non-periodic actions comprise at least one of:
a system information block (SIB) decode,
one or more actions related to sending or receiving short message service (SMS) messages,
one or more actions related to recovering from an out-of-service (OOS) indication,
one or more actions related to cell reselection,
intra-frequency cell measurements,
inter-frequency cell measurements, or
inter-radio access technology (RAT) cell measurements.

5. The UE of claim 1, wherein, when the tune away is associated with one or more base-band resource outage periods associated with the first subscription, the at least one request to suspend one or more second actions associated with the first subscription comprises a request for the first BS of the first RAN to suspend transmissions of uplink and downlink grants on all activated component carriers associated with the first subscription.

6. The UE of claim 1, wherein, when the tune away is associated with one or more base-band resource outage periods associated with the first subscription, the at least one request to suspend one or more second actions associated with the first subscription comprises a request for the first B S of the first RAN to suspend any upcoming bandwidth part switching on all activated carriers associated with the first subscription.

7. The UE of claim 1, wherein, when the tune away is associated with one or more radio frequency (RF) receiver chains outage periods associated with the first subscription, the at least one request to suspend one or more second actions associated with the first subscription comprises at least one of:
a request for the first B S of the first RAN to suspend transmissions of uplink and downlink grants on all or a selected set of activated component carriers associated with the first subscription except a primary component carrier associated with the first subscription, or
a request for the first B S of the first RAN to suspend any upcoming bandwidth part switching on all or a selected set of activated component carriers associated with the first subscription except for a primary component carrier associated with the first subscription.

8. The UE of claim 1, wherein the one or more processors are further configured to cause the UE to transmit the information to the first B S of the first RAN indicating the tune away in a media access control control element (MAC-CE).

9. The UE of claim 1, wherein the one or more processors are further configured to cause the UE to transmit additional information to the first BS of the first RAN, after performing the one or more first actions associated with the second RAN, indicating that the tune away has been completed and a request to resume the one or more second actions associated with the first subscription.

10. The UE of claim 9, wherein the request to resume the one or more second actions associated with the first subscription includes a request to resume transmission of at least one of uplink grants or downlink grants associated with the first subscription.

11. The UE of claim 9, wherein the additional information comprises a scheduling request (SR) associated with the first subscription.

12. The UE of claim 9, wherein the one or more processors are further configured to cause the UE to transmit the additional information to the first BS of the first RAN in a media access control control element (MAC-CE).

13. The UE of claim 1, wherein the information indicating the tune away further includes an expected duration of the tune away associated with the first RAN.

14. The UE of claim 13, wherein the expected duration of the tune away provides an indication to resume the one or more second actions associated with the first subscription after the expected duration of the tune away.

15. The UE of claim 1, wherein the one or more processors are further configured to cause the UE to perform the tune away associated with the first subscription to perform the one or more first actions associated with the second subscription, wherein, during the tune away, the UE operates in an idle mode associated with the first subscription and a connected mode associated with the second subscription.

16. A first base station (BS) of a first radio access network (RAN) for wireless communication, comprising:
a memory comprising executable instructions; and
one or more processors configured to execute the executable instructions and cause the first BS to:
communicate with a user equipment (UE) in a connected mode using a first subscription associated with a first subscriber identity module (SIM) of the UE;
receive information from the UE indicating that a tune away associated with the first RAN will occur to allow the UE to perform one or more first actions associated with a second subscription of the UE associated with a second SIM, wherein:
the information includes at least one request to suspend one or more second actions associated with the first subscription, and
the one or more processors are configured to receive the information prior to the tune away; and
suspend the one or more second actions associated with the first subscription during the tune away.

17. The first BS of claim 16, wherein the first subscription comprises a default data subscription (DDS) and the second subscription comprises a non-default data subscription (n-DDS).

18. The first BS of claim 16, wherein the one or more first actions associated with the second subscription comprise one or more non-periodic actions.

19. The first BS of claim 16, wherein the one or more non-periodic actions comprise at least one of:
a system information block (SIB) decode,
one or more actions related to recovering from an out-of-service (OOS) indication,
one or more actions related to sending or receiving short message service (SMS) messages,
one or more actions related to cell reselection,
intra-frequency cell measurements,
inter-frequency cell measurements, or
inter-radio access technology (RAT) cell measurements.

20. The first BS of claim 16, wherein:
when the tune away is associated with one or more base-band resource outage periods associated with the first subscription, the at least one request to suspend one or more second actions associated with the first subscription comprises a request for the first BS of the first RAN to suspend transmissions of uplink and downlink grants on all activated component carriers associated with the first subscription, and
the one or more processors are further configured to cause the first BS to suspend the one or more second actions associated with the first subscription during the tune away by suspending the transmissions of the uplink and downlink grants on all the activated component carriers associated with the first subscription during the tune away.

21. The first BS of claim 16, wherein:
when the tune away is associated with one or more base-band resource outage periods associated with the first subscription, the at least one request to suspend one or more second actions associated with the first subscription comprises a request for the first BS of the first RAN to suspend any upcoming bandwidth part switching on all activated carriers associated with the first subscription, and
the one or more processors are further configured to cause the first BS to suspend the one or more second actions associated with the first subscription during the tune away by suspending the upcoming bandwidth part switching on all the activated carriers associated with the first subscription.

22. The first BS of claim 16, wherein:
when the tune away is associated with one or more radio frequency (RF) receiver chains outage periods associated with the first subscription, the at least one request to suspend one or more second actions associated with the first subscription comprises at least one of:
a request for the first B S of the first RAN to suspend transmissions of uplink and downlink grants on all or a selected set of activated component carriers associated with the first subscription except a primary component carrier associated with the first subscription, or
a request for the first BS of the first RAN to suspend any upcoming bandwidth part switching on all or a selected set of activated component carriers associated with the first subscription except for a primary component carrier associated with the first subscription, and
the one or more processors are further configured to cause the first BS to suspend the one or more second actions associated with the first subscription during the tune away by at least one of:
suspending the transmissions of the uplink and downlink grants on all or the selected set of activated component carriers associated with the first subscription except the primary component carrier associated with the first subscription, or
suspending any of the upcoming bandwidth part switching on all or the selected set of activated component carriers associated with the first subscription except for the primary component carrier associated with the first subscription.

23. The first BS of claim 16, wherein the one or more processors are further configured to cause the first BS to receive the information indicating the tune away in a media access control control element (MAC-CE).

24. The first BS of claim 16, the one or more processors are further configured to cause the first BS to:
receive additional information from the UE indicating that the tune away has been completed and a request to resume the one or more second actions associated with the first subscription; and
resume the one or more second actions associated with the first subscription based on the request to resume the one or more second actions associated with the first subscription.

25. The first BS of claim 24, wherein:
the request to resume the one or more second actions associated with the first subscription includes a request to resume transmission of at least one of uplink grants or downlink grants associated with the first subscription, and
the one or more processors are further configured to cause the first BS to resume the one or more second actions associated with the first subscription by resuming transmission of at least one of uplink grants or downlink grants associated with the first subscription.

26. The first BS of claim 24, wherein the one or more processors are further configured to cause the first BS to receive the additional information in a media access control control element (MAC-CE).

27. The first BS of claim 24, wherein the additional information comprises a scheduling request (SR) associated with the first subscription.

28. The first BS of claim 16, wherein:
the information indicating the tune away further includes an expected duration of the tune away associated with the first RAN,
the expected duration of the tune away provides an indication to resume the one or more second actions associated with the first subscription after the expected duration of the tune away, and
the one or more processors are further configured to cause the first BS to resume the one or more second actions associated with the first subscription after the expected duration of the tune away.

29. A method for wireless communication by a user equipment (UE), comprising:
communicating with a first base station (BS) of a first radio access network (RAN) in a connected mode using a first subscription associated with a first subscriber identity module (SIM) of the UE, wherein:
the UE includes a second subscription associated with a second SIM for communicating with a second BS of a second RAN, and
the UE operates in an idle mode associated with the second subscription while communicating with the BS using the first subscription in the connected mode;
determining a tune away associated with the first RAN will occur to allow the UE to perform one or more first actions associated with the second subscription; and
transmitting, prior to the tune away, information to the first B S of the first RAN indicating the tune away and at least one request to suspend one or more second actions associated with the first subscription.

30. A method for wireless communication by a first base station (BS) of a first radio access network (RAN), comprising:
communicating with a user equipment (UE) in a connected mode using a first subscription associated with a first subscriber identity module (SIM) of the UE;
receiving information from the UE indicating that a tune away associated with the first RAN will occur to allow the UE to perform one or more first actions associated with a second subscription of the UE associated with a second SIM, wherein:
the information includes at least one request to suspend one or more second actions associated with the first subscription, and
receiving the information indicating that the tune away associated with the first RAN will occur comprises receiving the information prior to the tune away; and
suspending the one or more second actions associated with the first subscription during the tune away.
